(19) United States
(12) Patent Application Publication
(10) Pub. No.: US 2014/0279339 A1
(43) Pub. Date: Sep. 18, 2014

(54) Method and Apparatus for a Composite Trading Exchange System

(71) Applicant: Joseph Horowitz, Lawrence, NY (US)

(72) Inventor: Joseph Horowitz, Lawrence, NY (US)

(21) Appl. No.: 13/802,666

(22) Filed: Mar. 13, 2013

(51) Int. Cl. G06Q 40/04

(52) U.S. Cl. CPC G06Q 40/04
USPC 705/37

(57) ABSTRACT

A method and apparatus of a composite exchange for the trading of instruments under multiple types of rules is described. Participants in the composite exchange use known trading rules that are processed in a fair manner. This ensures that liquidity on the composite exchange is maximized while trading remains fair to all parties.

### FIELD OF THE DISCLOSURE

The present disclosure relates generally to a composite exchange for the trading of instruments under multiple types of rules and more particularly to ensuring that liquidity interaction on such a composite exchange is maximized while trading remains fair to all parties.

### BACKGROUND

Trading exchanges for the trading of stocks, bonds, options, commodities, currency, derivatives and other instruments may include one or more of the following features.

1. Executed trades (matches) occur in real-time.

2. Executed trades (matches) occur at set intervals (auctions).

3. Orders executed are traded at an average price based on a benchmark (smooth price).

4. Any combination of the above features 1-3. For example, trading may begin and end with an auction and allow real-time trading in between. Or for another example, a match is made in real-time but final prices are delayed until a smooth price is calculated.

5. Advanced order types or algorithms that permit some or all parts of an order's quantity to be hidden, appear at a different price and/or change prices dynamically based on the state of, or activity in, the market.

6. Market data may be real-time or blurred (sent at set intervals)

7. Market data may disclose who the contributors are or be anonymous

8. Market data may only partially disclose order and/or trade details, such as price, side, quantity, direction and action.

9. Some exchanges may allow a counterparty or both counterparties to a trade to agree to the trade price after the match is made. This is called “Last Look” and is common in the foreign exchange market on anonymous exchanges.

10. Market data may be unique per-client (perhaps based on credit) or common to all participants on the exchange

11. Market data from exchanges operated by the same entity may be delivered over one or more electronic sessions

There are a number of separate, non-composite exchange types that presently exist for trading that may include one or more of the above-specified features. Each exchange type offers value and appeal to a specific type of trading strategy. These types include:

1. “Lit” exchanges, where tradable orders (liquidity) and executed trades (matches) may be fully disclosed and disseminated. They are called “lit” because the orders and executions are fully available to the public and/or the members of the exchange. Lit exchanges may be used by algorithm-based and high-frequency trades and those who want to see the exact market state and depth or wish to manipulate the market to their advantage by sending specific order flows.

2. “Dark” exchanges, where tradable orders (liquidity) and executed trades (matches) are not disclosed and disseminated through market data. They are called “dark” because the orders and executions are not available to the public or even to other exchange members. Dark exchanges appeal to traders that wish to limit their market impact by hiding their activity, such as when attempting to trade large orders.

3. “Gray” exchanges, where tradable orders (liquidity) and executed trades (matches) details are not fully disclosed or disseminated through market data. They are called “gray” because the orders and execution details are only partially available to the public and/or members of the exchange. Gray exchanges offer a compromise between the lit and dark exchanges and may be used in “over the counter” asset classes such as foreign exchange currency trading when full disclosure is undesirable and not mandated by law.

These non-composite and separate present-day electronic trading exchanges offer a specific type of service that appeal to some participants in the market but not to all participants. Thus traders or trading algorithms may send or “split” order flow among different exchange types to take advantage of the value offered by a specific exchange type. Splitting orders among exchanges is also often used to achieve “best execution” because executing on one exchange type may not always afford the same opportunity for best price and may result in information leakage that may negatively impact the assets price going forward (resulting in poor execution). As a result of this “split”-based strategy, traders or trading algorithms search for liquidity to trade against knowing that liquidity is often divided among the various exchanges types available that trade the same asset (due to the value offered by each exchange type).

As a practical matter, there may be multiple problems with this approach of splitting exchanges. Prices may move against a participant as the result of market impact if there are too many orders sent to lit exchanges resulting in information leakage. Or sending only to lit exchanges or only to dark exchanges may result in missed trading opportunities against liquidity available on the other exchange types. This problem may not necessarily be solved by sending the same orders to multiple exchange types simultaneously since this may result in an over-fill condition (too much traded). Thus, exchange participants may be forced to split orders and rotate them across multiple exchanges of the same type. This may result in the loss of time-priority positioning when orders are withdrawn and then reentered. Further, splitting orders is complex and the execution results are often imperfect. It requires a great deal of manual effort and often additional algorithmic-trading and smart-order-routing (SOR) software to automate the complexity.

This fracturing of liquidity has led to the creation of Execution Management System (EMS) software-aggregation systems that collect market data from, and can send orders to, multiple exchanges simultaneously. Along with associated algorithms and SOR software, EMS software performs the splitting, rebalancing and liquidity seeking functions necessary to function in a multiple non-composite exchange environment.

Nonetheless, attempts to link exchanges of different types via aggregators and algorithmic-SOR logic from outside each exchange fails to provide the trader with the ability to trade against the best available liquidity with the least amount of market impact at any single point in time. Order quantity sent to one type of exchange cannot execute on another type of exchange unless canceled and resubmitted to the other type; hence it can only rest within one type of exchange at any one time. Also, canceling and resending orders results in time-priority penalties, whilst using place-holder orders results in order-to-fill ratio fines (on some exchanges) and can also result in over-fill conditions should the market move sharply.

In recognition of fractured liquidity resulting in poor execution for exchange participants on any single exchange, the U.S. Securities and Exchange Commission (SEC) established Regulation National Market System (Reg. NMS). The SEC recognized that retail investors will participate directly in the U.S. equity markets only to the extent they perceive that their orders will be treated fairly and efficiently. Reg. NMS attempts to address the problem of fractured liquidity in government-regulated exchanges by linking exchanges of “like-type” (all regulated-lit markets) into a semi-real-time unified market at the “top of book” level.

To meet the SEC's objectives for Reg. NMS, investors of all types should have confidence that their orders will be handled in a fair and orderly fashion. Yet orders that ultimately never receive an execution are likely to be the very orders that would have been most profitable for the investor (e.g., when the order was to buy a stock and the stocks price climbed after the trade-through occurred).

One solution to this problem has been implemented in the foreign exchange market by EBS Group Limited. EBS created a single unified exchange by integrating “like-type” exchanges using arbitrators distributed across multiple regions. This is disclosed in U.S. Pat. Nos. 6,983,259, 7,184,982 and 7,366,690.

Ultimately Reg. NMS and EBS fail the criteria of “absolute fairness” for linked exchanges of like-type. Also, while linking like-type exchanges provided access to more liquidity, it does not provide any access to liquidity resting on other exchange types. Also, like-type exchange linkages may be restricted to lit and gray exchanges only, where price is a key element of all orders. Because traders often choose different types of exchanges that offer differing, valuable features (such as dark exchanges that result in very low information leakage and market impact) linking like-type exchanges does not allow access all liquidity resting on across all the various different exchange types.

Accordingly, there is a need for a composite exchange trading system that will incorporate multiple exchange types simultaneously with overall transparent rules to ensure universal fairness and maximum liquidity to all participants.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a flowchart of a non-composite multiple-exchange trading system illustrating potential inefficiencies.

FIG. 2A is a flowchart of a composite exchange trading system illustrating absolute time priority rules in accordance with some embodiments.

FIG. 2B is a flowchart of a composite exchange trading system illustrating exchange-based time priority rules in accordance with some embodiments.

FIG. 2C is a flowchart of a composite exchange trading system illustrating size-based priority rules in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As will be detailed further, a composite exchange has a composite exchange rule set and a number of trades. Each trade has a trade attribute set that comprises trade quantity, trade price, trade time, trade instrument and trade type (buy or sell), as well as trade counterparties (buyer and seller, unless the exchange is providing liquidity from the books of a single provider, and thus requires only one counterparty). There are multiple individual exchanges each of which has individual exchange rules sets that differ based on the trade attribute set for the trade placed in their respective exchanges. The individual exchanges operate under the governance of the composite exchange rule set that governs the placement of each trade within a specific individual exchange based on the trade attribute set for that trade and governs the execution of that trade based on the trade attribute set for that trade.

Eroding Investor Confidence in Non-Composite Exchange Systems

FIG. 1 illustrates a non-composite trading system demonstrating that a plurality of exchanges (nodes) 50, 60 that are linked electronically may lack absolute fairness in price and time priority. For example, Order #1 to buy 1 share of instrument “X” at a price of $10 arrives within Node #1 at time T₀ 110. Having no liquidity to trade against, Order #1 is sent to another linked exchange Node #2 T₁ 120. While Order #1 is in transit, at time T₂ Order #2 to sell 1 share of instrument “X” at a price of $9 arrives within Node #2 130. At time T₃ Order #3 to buy 1 share of instrument “X” for a price of $9 arrives at Node #2. Since Node #2 has a buy and sell order at the same price for the same instrument “X” and Order #1 with a better price has not yet arrived, Node #2 executes Trade A 150 and delivers the trading information to Node #1 140. This is a known as a race condition.

At time T₄, the details of trade #1 arrive at Node #2 170. At that time, however, the one share of instrument “X” had previously been sold at time T₃ for a lower price of $9. The confidence of investor who placed Order #2 will be eroded because a previously-placed higher-priced Order #1 would have been a better trade. At time T₅ the details of Trade A arrive at Node #1. The confidence of investor who placed Order #1 will be eroded because a later-placed Order #3 for a lower price was executed instead of Order #1.

As FIG. 1 demonstrates, price and time priorities may be key fairness rules that are inviolate among multiple exchanges. When not guaranteed, investor confidence is eroded as others jump the market and the original investor's orders are traded at worst prices.

The Composite Trading Exchange System

A composite trading exchange system is able to provide a solution to maximize liquidity and fairness within which different exchange types can exist simultaneously. The composite trading exchange may include a set of rules that allows liquidity (orders) to both execute (trade) within each exchange type and across exchange types that provide fairness and, where desirable, transparency. Furthermore, a composite trading exchange may offer traders a place to send and trade their orders on the exchange type of their choice (offering the specific value they seek) while simultaneously allowing said orders to still trade against liquidity on other exchange types at the same composite exchange. This will avoid the need to fracture or rotate orders across different exchange types or to use an aggregator or algorithm to manage fracturing outside the exchange of choice.

Possible Internal Rules for the Composite Trading Exchange System

The composite exchange system may include a set of rules that provides for cross-exchange-type execution (trading) to afford any order the ability to execute against liquidity within any other exchange type and to move the order or parts of the order among different exchange types. A composite exchange system may also include different exchange types and series of internal rules that govern trading between exchange types. Such internal rules may include the following.

1. Attributes of orders to assign to the proper exchanges

a. Quantity of the order—for example, route smaller order to lit exchanges (market impact is acceptable), medium sized orders to gray exchanges (some market impact is acceptable) and larger orders to dark exchanges (avoid market impact as much as possible).

b. Price of the order—for example, route to a specific exchange if the price outside the market by a percentage; this would allow segregation of orders that are unlikely to trade into low-activity exchanges reducing the processing overhead of more active exchanges.

c. Quantity to display—specific amount to display in any market data generated by the order; for example if the amount to display is very small then routing to a lit pool as an “iceberg” order may be advisable, even if the order itself is large in quantity.

d. Order symbol—specific symbols may only trade on certain exchange types based on how liquid they typically are.

2. Essential order attributes to perform trades across exchange types.

a. This rule may use the price attribute of an order (or designated market orders that may trade at any price) as the key field to allow orders to perform executions across exchange types, even if the order is designated for an exchange type that doesn't normally allow or need price as an order attribute (such as a dark exchange that execute at a smoothed rate or price benchmark).

3. Triggering trades across exchange types. A triggering event or time may allow orders to trade across exchanges. When quantity trades across exchanges, including the rules for market data information, it always obeys the rules of the exchange type on which each order executes, since the transfer has by definition satisfied the order's criteria required for transferring quantity. Criteria may include:

a. “Minimum Fill” as a trigger for cross exchange execution. Once an order within one exchange type may be traded by other orders for a minimum quantity within all the orders limit prices then a cross-exchange execution may occur between them.

b. The end of trading session or auction time on one exchange type may permit remaining orders to trade on other exchange types, without losing relative position in queue, since the composite exchange stores information about time of receipt across all exchange types.

c. An opportunity of sufficient value (better price) that appears on a different exchange type may trigger an order to trade across the exchanges.

4. Determining which orders should be traded across exchange types when more than one possibility exists. When executions may occur across multiple exchange types, fairness rules may be used to determine the orders that will participate in the trade.

a. Static priority ordering between exchange types; for example, dark exchanges execute before gray exchanges that execute before lit exchanges, and exchanges with real-time execution take priority over exchanges that execute only at the close of an auction period.

b. Time priority ordering between orders across exchange types; for example, should a dark exchange order be eligible to trade against both lit and gray exchange orders it may execute them in time priority order regardless of which exchanges they rest on or it may use one or some of the orders to produce a measure to make a decision (such as the exchange with the oldest order, or the oldest average order age).

c. Price priority ordering between orders across exchange types; for example, should a dark exchange order be eligible to trade against both lit and gray exchange orders it may execute them in the order that result in the best possible execution price for the dark exchange order.

5. Determining which orders receive price improvement when executing across exchanges. When trading across exchange types, fairness rules may be used to determine aggressor and aggresse status and which orders may be given price improvement. Such rules may include:

a. Static priority ordering between exchange types; for example, dark exchanges receive price improvement before gray exchanges which receive price improvement before lit exchanges.

b. Time priority; for example, older orders always receive price improvement regardless of their exchange.

6. Events that open the possibility to move orders between exchange types. Trading or modifying and order on one exchange type may make the order available to be transferred to another exchange type.

a. Time priority may be maintained when moving the order to a different exchange type due to the order either: i) partially trading and being reduced in quantity; or ii) reaching a particular point in time when an auction or end of a trading session occurs with an order not completely executed.

b. Modifying an order, especially to reduce quantity, that may also retain time priority ordering when moving the order to a different exchange type

7. Post-trade events out of control of the exchange and the restoration of fairness. Should a guaranteed match be later rejected due to a “last-look” by a counterparty to the match that may occur much later (sometimes as long as 30 seconds later), each order may return to their proper queue position within its exchange based on its time priority prior to the match.

Operation of the Composite Trading Exchange System

In one alternative of the composite exchange system, orders may arrive and be placed automatically within an exchange type based on their properties (such as quantity). Rules may automatically determine and route orders to the appropriate exchange on arrival based on the size of each order. A small order may be placed in a lit exchange (to advertise availability), a medium size order may be placed in a gray exchange (to limit market impact), and a large order may be placed on a dark exchange (to avoid market impact as much as possible).

In another alternative, orders may be designed by clients of the composite exchange system to be entered into a specific exchange type upon arrival.

As a further example, each exchange type within the composite exchange system may be free to prioritize and trade orders according to its unique rules within that exchange type. For example an order entered into a dark exchange that does not apply price limits to orders may still execute against another order within the dark exchange regardless of the limit prices entered for those orders. This is because: 1) the dark exchange uses time priority for trading regardless of price; 2) orders rest in the dark exchange only where there is no quantity to match on the opposite side; and 3) trades executed within the dark exchange are priced against a benchmark rate and are unrelated to each order's price.

To allow orders entered at the composite exchange system to execute across all exchange types support, orders may include enough details to execute within each exchange type offered. For example to execute across lit, gray and dark exchange types, orders may include a price (even though a price may not necessary for a dark exchange type). Thus under this rule, cross-exchange execution may only take place on orders that include a price. Alternatively, a composite exchange may utilize a series of rules to derive fair use instructions for any order details missing for a particular exchange type, based on a combination of static and real-time information.

For example, an order entered into a dark exchange with a limit price may execute against any order entered within a lit exchange if the limit prices matches or is better than the price in the lit exchange and there is no liquidity on the other side of the dark exchange. A fairness rule may specify that resting dark exchange orders are prioritized lower than lit exchange orders on the lit exchange. The rule may also specify that lit exchange order may not bypass a dark exchange order by time-arrival if the dark exchange order is determined to match a resting lit exchange order. This means that the dark exchange order take price- and time-priority over any new lit exchange orders arriving should it price-match an existing order already resting within the lit exchange.

Another example may be to allow an order within a dark exchange to only trade with orders in a lit exchange if the price is within a limit and the total quantity traded exceeds a minimum amount. This would allow activity on a lit exchange to move past a limit price for an order on a dark exchange but only to the extent that trading quantities fall under a minimum amount. Only trading quantities above the minimum amount in the lit exchange would create market impact on the dark exchange. Such larger movements may result in participants on the dark exchange being disadvantaged if they are not allowed to trade across the exchange types onto the lit exchange.

Exchanges may also prioritize trades using either the status related to the aggressor, or based on order time, or a combination of the two. Under these rules, for example, the aggressor gray exchange orders may receive price advantage over lit exchange orders, and dark exchange orders may receive price advantage over both gray and lit exchange orders. As a further example, there may be a rule where the dark exchange moves an order to a gray exchange or lit exchange if the order's open quantity reaches less than a minimum size and becomes too small to remain in a dark exchange. The order may then enter the gray or lit exchange with a “time stamp” either of the time of the original order or of the time when the order was transferred to the gray or lit exchange.

Linking working electronic exchanges of different types may be accomplished within exchanges that operate within the same physical site or different physical sites. The linking may be implemented either in software, hardware or a combination of both. This linkage allows trading between these simultaneously operating exchanges to occur based on rules that are easily understood.

The linking is designed to provide a goal of guaranteeing absolute fairness between linked exchanges of like or unlike types within the composite exchange system. The rules may also respect the nature of time-priority where expected. This could mean the time when the rule is triggered or the time when the order arrived; either way the exchange may ensure that no unfair trading happens around the order due to race conditions between exchanges. Thus, time priority may be maintained such that each order's processing (arrival or modification) or trade time across all exchanges may be used to guarantee time priority executions or queue placement within an exchange when trading or moving between exchanges.

If a guaranteed match is later rejected due to “last-look” by a counterparty to the match, which may take place a good deal of time later (sometimes as long as 30 seconds later), the order could return to its proper queue position within its exchange based on its time priority prior to the match and not be penalized for the rejected match (since it was out of control of the exchange). Thus, the rules may not be best-effort or involve penalties if they fail, rather the trades could be re-characterized to respect the time stamps and rules previously established by the composite exchange system so as to promote investor confidence.

### Example 1

### A Three-Stage Composite Trading Exchange System

As a further example, rules for a three-stage foreign exchange may include the following:

1. Foreign exchange orders less than 5 Million in base-currency quantity would be placed in the lit exchange.

2. Foreign exchange orders equal to 5 Million but less than 20 Million in base-currency quantity would be placed in the gray exchange.

3. Foreign exchange orders equal to or greater than 20 Million in base-currency quantity would be placed in the dark exchange.

It should be noted that the above three rules could use different quantities across different traded symbols.

The composite exchange system may also comprise a multiple currency exchanges with a 5 million (5M) minimum quantity rule. Thus, if a minimum of 5M in base-currency quantity order is resting in the lit exchange and is also within the price limit of at least 5M in base-currency quantity resting in the gray exchange, then a cross exchange executions may take place amounting to at least 5M in quantity. This rule guarantees that the market will not move more than the 5M quantity beyond the limit price of a gray exchange order. This protects the gray exchange participant from missing the opportunity to trade by best execution should the market move positively by a sufficient quantity such that the gray exchange participant would have been economically harmed to have missed the opportunity to trade. At the same time it protects the gray exchange order from having market impact due to small fluctuations below 5M in the lit exchange.

Should a minimum of 20 Million in base-currency quantity be resting in the lit or gray exchanges in combination and also be within the price limit of at least 20 Million in base-currency quantity resting in the dark exchange, then cross-exchange executions may take place amounting to at least 20 Million in quantity. This rule guarantees that the market will not move more than the 20M quantity beyond the limit price of a dark exchange order. This protects the dark exchange participant from missing the opportunity to trade by best execution should the market move positively by a sufficient quantity such that the dark exchange participant would have been economically harmed to have missed the opportunity to trade. At the same time it protects the dark exchange order from having market impact due to small fluctuations below 20M in the lit and gray exchanges.

If a dark exchange order's open quantity is reduced to below 20 Million in remaining base-currency quantity, it may automatically be moved to the gray exchange and be positioned in its price-time priority (time may be either arrival or when the order was reduced sufficiently).

If a gray exchange order's open quantity is reduced to below 5 Million in remaining base-currency quantity, it may automatically be moved to the lit exchange and be positioned in its price-time priority (time may be either arrival or when the order was reduced sufficiently).

Following the structure set forth above, the operation of the composite exchange system may be determined by pre-set rules as to how trades are processed within and between the exchanges. The goals of the composite exchange system are achieved if these rules are fully disclosed in advance and if the rules are applied in a fair and equitable manner to all exchanges and trades within the composite exchange system. As demonstrated in the examples below, such pre-set rules may produce different outcomes based on the same set of initial facts.

### Example 2

### Absolute Time Priority

A composite exchange system may process trades on an “absolute time priority” scheme. Under this scheme, each trade in the composite exchange system is executed on a “first-come, first-served” basis without regard as to which exchange the trade was placed in or the size of the trade,

FIG. 2A illustrates a set of trades under these rules. A composite exchange system includes a lit exchange 200 and a gray exchange 210.

At time T₀, order #1 to buy 2 million of an instrument “Y” at a price of $11 arrives and is placed in the lit exchange 220 because the quantity of the trade is less than 5M, which is not large enough to move it to the gray exchange. At time T₁ order #2 to sell 5 million of an instrument “Y” at a price of $10 and is placed in the gray exchange 230 because the quantity of the order meets the 5M threshold necessary to move such a trade to the gray exchange. Nevertheless, order #1 will not trade against order #2 240 because the quantity in the lit exchange is then too small (less than 5M) to incur a “market impact” penalty to match order #1 and order #2.

At time T₂, order #3 to buy 4 million of an instrument “Y” at a price of $12 arrives and is placed in the lit exchange 250 because the quantity of the trade is less than 5M, which is not large enough to move it to the gray exchange. But now that the amount of trades sought in the lit exchange (6M) is large enough (5M and over), orders #1 and #3 may now be traded with order #2 at their resting prices in price. In this composite exchange system, the rules provide that trades are executed in absolute time priority order. Thus, at time T₃ order #2 and order #1 trade 2M shares at $11 260. At time T₄ order #2 and order #3 trade 3M shares at $12 270. These trades are illustrated in FIG. 2A as straddling the two exchanges. The remaining 1M shares of order #3 remain for later trades at time T₅ 280.

Under these rules, order #2 is afforded the opportunity to trade because it is worth the market impact penalty to execute orders larger than 5M in quantity. No aggregator or smart order router is needed to make this decision external to the exchange. It is made by the composite exchange system itself.

### Example 3

### Exchange-Based Time Priority

A composite exchange system may process trades on an “exchange-based time priority” scheme. Under this scheme, all eligible trades in the composite exchange system originating from the exchange where the corresponding order is placed are executed before orders that originated from another exchange. Within these categories, trades are executed on a “first-come, first-served” basis.

FIG. 2B illustrates a set of trades under these rules. A composite exchange system includes a lit exchange 300 and a gray exchange 310. At time T₀, order #1 to buy 2 million of an instrument “Y” at a price of $12 arrives and is placed in the lit exchange 320 because the quantity of the trade is less than 5M, which is not large enough to move it to the gray exchange. At time T₁ order #2 to sell 9 million of an instrument “Y” at a price of $10 and is placed in the gray exchange 330 because the quantity of the order meets the 5M threshold necessary to move such a trade to the gray exchange. Nevertheless, order #1 will not trade against order #2 340 because the quantity in the lit exchange is then too small (less than 5M) to incur a “market impact” penalty to match order #1 and order #2.

At time T₂, order #3 to buy 2 million of an instrument “Y” at a price of $12 arrives and is placed in the lit exchange 350 because the quantity of the trade is less than 5M, which is not large enough to move it to the gray exchange 360. Thus, the amount of trades sought in the lit exchange (4M) is not large enough (5M or more) to trade with order #2 in the gray exchange 360. At time T₃ order #4 arrives to buy 6M of an instrument “Y” at $11. Because this order is greater that 5M, the trade is placed in the gray exchange 370. Because orders #2 and #4 are in the same exchange, they can interact immediately and trade the fully quantity of order #4 380, leaving a remaining quantity in order #2 below the 5M threshold. At this point in time T₅ order #2 is transferred to the Lit exchange 385 and can naturally interact with orders #1 and #3 in their time priority sequence on the Lit exchange at times T₆ 390 and T₇ 400. This leaves a partial order #3 to buy the remaining 1M shares to be traded at time T₈ or thereafter.

In this composite exchange system, the rules provide that trades are executed in “exchange-based time priority” order. That is, all buy orders that were originally placed in the gray exchange where the corresponding sell order is located will be executed before the trades that originated in the lit exchange. Within these categories, trades are executed in time-order. Using these rules, at time T₄ buy order #4 takes precedence because it originally was placed in the same exchange (grey) as sell order #2. Thus, all 6M shares of order #4 are executed against order #2 at $10. Now that all gray exchange buy orders have been executed, buy orders from the other exchanges (in this case, the lit exchange 300) are processed in time-stamp order, however this only takes place should the remaining quantity in order #2 be small enough to transfer the order into the lit pool (now that the quantity remaining is sufficiently small that the trader is no longer concerned about market impact; a lit exchange is now more advantageous for trading the remaining quantity). Once within the lit pool order #2 can interact directly with orders #1 and #3. Since order #1 arrived before order #3, at time T₆ all 2M of order #1 are executed against order #2 at $12 390. At time T₇ 1M of order #3's buy order are executed against order #2 at $13 400. The remaining 1M shares of order #3 remain for later trades at time T₈ 410 within the lit pool.

The composite exchange system thus results in increased liquidity across trading platforms under a fairly-applied set of rules. This fair and even-handed approach to trading results in greater aggregate market participation even though, in single instances, trades may not be executed in a manner that is preferable to one participant. For example, in the series of trades in FIG. 2B, the seller behind order #2 would have preferred to executed first with order #3 (that was offering the highest price of $13), then with order #1 ($12) and then with order #4 ($11). Under the rules of the exchange, order #4 ($11) was executed first, followed by order #3 ($12) and then order #1 ($13). But the rules of the composite exchange are applied fairly, and can be understood by traders, who can benefit from the simplicity and increased liquidity and faster re-routing time within one composite exchange system, as opposed to the performance and complexity achievable with an aggregator or smart order router external to the composite exchange system. As order #2 is executed it is automatically transferred to the correct pool based on its remaining size, allowing it to interact with orders that were not available to it whilst it was too large and market impact was a concern.

### Example 4

### Size-Based Priority

A composite exchange system may process trades on a “size-based priority” scheme. Under this scheme, all eligible trades in the composite exchange system are executed in size order, with the larger trades being executed before smaller trades.

FIG. 2C illustrates a set of trades under these rules. A composite exchange system includes a lit exchange 500 and a gray exchange 510. At time T₀, order #1 to buy 2 million of an instrument “Y” at a price of $14 arrives. It is placed in the lit exchange 520 because the quantity of the trade is less than 5M, which is not large enough to move it to the gray exchange. At time T₁ order #2 to sell 7 million of an instrument “Y” at a price of $10 arrives and is placed in the gray exchange 530 because the quantity of the order meets the 5M threshold necessary to move such a trade to the gray exchange. Nevertheless, order #1 will not trade against order #2 540 because the quantity in the lit exchange is then too small (less than 5M) to incur a “market impact” penalty to match order #1 and order #2.

At time T₂, order #3 to buy 1 million of an instrument “Y” at a price of $13 arrives and is placed in the lit exchange 560 because the quantity of the trade is less than 5M, which is not large enough to move it to the gray exchange. Thus, the amount of trades sought in the lit exchange (3M) is not large enough (5M or more) to trade with order #2 in the gray exchange 570. At time T₃ order #4 arrives to buy 3M of an instrument “Y” at $11 580. Now that the total demand for buying instrument “Y” exceeds 5M, all outstanding buy orders (#1, #3 and #4) are eligible to trade with sell order #2 530 that had been placed in the gray exchange.

In this composite exchange system, the rules provide that cross-exchange trades are executed in “size-based priority” order. Using these rules, at time T₄ buy order #4 is executed against order #2 590. Order #4 takes precedence because its size of 4M is greater than the size of order #1 (2M) and order #3 (1M). At time T₅ buy order #1 of 2M is executed against order #2 at $14 600. At time T₆ buy order #2 of 1M is executed against order #2 at $13 610. These three trades are illustrated in FIG. 2C as straddling the two exchanges. The remaining 1M shares of order #2 remain for later trades at time T₇ 620 and can be transferred to the Lit exchange (as the remaining quantity is too small for the trader to be concerned about market impact; a lit exchange is now more advantageous for trading the remaining quantity).

The fair and even-handed approach in these examples results in greater aggregate market participation even though, in single instances, trades may not be executed in a manner that is preferable to one participant. For example, in the series of trades in FIG. 2B, the seller behind order #2 would have preferred to executed first with order #3 (that was offering the highest price of $13), then with order #1 ($12) and then with order #4 ($11). Under the rules of the exchange, order #4 ($11) was executed first, followed by order #3 ($12) and then order #1 ($13). As a further example, in the series of trades in FIG. 2C, the seller behind order #2 would have preferred to executed first with order #1 (that was offering the highest price of $14), then with order #3 ($13) and then with order #4 ($11).

Nevertheless, as these rules are applied in a fair and predictable manner with transparency that is known to all exchange participants, the participant in the composite exchange system is able to operate without an aggregator or smart order router. This system increases trading execution time and efficiency whilst maintaining the level of execution anonymity and reduced market impact each exchange type is arrayed and known for.

While the foregoing examples illustrate a composite exchange with two operable sub-exchanges, the concepts may easily be extended to multiple composite exchanges and multiple sub-exchanges or (equivalent order groupings), each of which may have unique trading and/or market data characteristics.

Accordingly, the composite exchange system may be a single execution engine for all liquidity across all exchange types. Market participants will no longer need to use aggregators or algorithms to access the component exchanges of the composite exchange system, which result in imperfect execution, or to rely on transference rules which are not inviolate in their respect for priority order, but rather will be able to achieve true best execution across all offered exchange types at a single composite exchange system. It offers a one-stop shop for the exchange features a trader participant is looking to leverage while allowing the orders sent to a specific exchange type the potential to interact with all liquidity available across all the exchange types at the composite exchange system though a known set of fair rules. The composite exchange system may attract liquidity from all exchange types into a central system because it has the advantage of trading across exchange types while protecting orders within each exchange type.

The implementation of the composite exchange system may take place in various formats and arrangements. Such implementation may take place in computer hardware, computer software or a combination of the two. The implementation may also take place in stand-alone networks, using publicly-available networks over the Internet or a combination of the two. The exchanges may take place in the same or disparate physical locations. The implementation may also be used for one or more tradable instrument, including without limitation stocks, bonds, options, futures, derivatives, currency, equities, assets, real estate, commodities, debt, warrants and the like, either alone or in combination. The implementation may take place in one or more composite exchanges that govern one or more individual exchanges, each of which has unique trading characteristics. Or the implementation may take place in one exchange that governs one or more individual sub-exchanges or equivalent order groupings, each of which may have unique trading and/or market data characteristics.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific composite circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

I claim:

1. An apparatus comprising:
an exchange, wherein the exchange has an exchange rule set;
a plurality of trades, where each trade has a trade attribute set, wherein the trade attribute set for each trade comprises trade quantity, trade price, trade time, trade instrument and trade type;
a plurality of sub-exchanges, wherein the plurality of sub-exchanges comprise a first sub-exchange having a first sub-exchange rule set and a second sub-exchange having a second sub-exchange rule set and wherein the first sub-exchange rule set and the second sub-exchange rule set differ based on the trade attribute set for the trade placed in their respective exchanges;
wherein the plurality of sub-exchanges operate under the governance of the exchange rule set;
wherein the exchange rule set governs the placement of each trade within a specific sub-exchange based on the trade attribute set for that trade; wherein the exchange rule set governs the execution of each trade based on the trade attribute set for that trade.

2. The apparatus as in claim 1:
wherein the exchange moves a first trade from the first sub-exchange to the second sub-exchange based on the placement of a second trade in the second sub-exchange.

3. The apparatus as in claim 2, wherein the movement of the first trade from the first sub-exchange to the second sub-exchange by the exchange is based on the trade quantity of the second trade.

4. The apparatus as in claim 2, wherein the movement of the first trade from the first sub-exchange to the second sub-exchange by the exchange is based on the trade quantity of the first trade.

5. The apparatus as in claim 1, wherein the placement of a trade within a specific sub-exchange by the exchange is based on the trade price.

6. The apparatus as in claim 1, wherein the placement of a trade within a specific sub-exchange by the exchange is based on the trade instrument.

7. The apparatus as in claim 1, wherein the first sub-exchange rule set discloses the trade price and the trade quantity for a trade located within the first sub-exchange to members of the first sub-exchange and to the exchange before the trade is executed and the second sub-exchange rule set discloses the trade price and trade quantity for a trade located within the second sub-exchange only to the exchange before the trade is executed.

8. The apparatus as in claim 1, wherein the first sub-exchange rule set discloses the trade price for a trade located within the first sub-exchange to members of the first sub-exchange and discloses the trade price and trade quantity for the trade to the exchange before the trade is executed and the second sub-exchange rule set discloses the trade price and trade quantity for a trade located within the second sub-exchange only to the exchange before the trade is executed.

9. The apparatus as in claim 1, wherein the first sub-exchange rule set discloses the trade price and the trade quantity for a trade located within the first sub-exchange to members of the first sub-exchange and to the exchange before the trade is executed and the second sub-exchange rule set discloses the trade price for a trade located within the second sub-exchange to members of the second sub-exchange and discloses the trade price and trade quantity for the trade to the exchange before the trade is executed.

10. The apparatus as in claim 1, wherein the exchange adjusts trade prices for execution of trades using an average price based on a benchmark.

11. The apparatus as in claim 1, wherein the exchange adjusts trade prices for execution of trades at the oldest trade price.

12. The apparatus as in claim 1, wherein the exchange adjusts trade prices for execution of trades at the average price between any two trades.

13. The apparatus as in claim 1, wherein the exchange adjusts trade prices for execution of trades at the average price of the trades taking place as a group at any one instance.

14. The apparatus as in claim 1, wherein the exchange rule set determines the order of execution of trades based on the trade time attribute of the trade.

15. The apparatus as in claim 1, wherein the exchange rule set determines the order of execution of trades based on the trade size attribute of the trade.

16. The apparatus as in claim 1, wherein the exchange rule set determines the order of execution of trades based on the placement of the trade in the sub-exchange and the time attribute of the trade.

17. A method comprising:
establishing an exchange, wherein the exchange has an exchange rule set;
processing a plurality of trades, where each trade has a trade attribute set, wherein the trade attribute set for each trade comprises trade quantity, trade price, trade time, trade instrument and trade type;
establishing a plurality of sub-exchanges, wherein the plurality of sub-exchanges comprise a first sub-exchange having a first sub-exchange rule set and a second sub-exchange having a second sub-exchange rule set and wherein the first sub-exchange rule set and the second sub-exchange rule set differ based on the trade attribute set for the trade placed in their respective exchanges;
operating the plurality of sub-exchanges under the governance of the exchange rule set;
governing the placement of each trade within a specific sub-exchange by the exchange based on the trade attribute set for that trade;
governing the execution of each trade by the exchange based on the trade attribute set for that trade.

18. The method as in claim 17, wherein the exchange moves a first trade from the first sub-exchange to the second sub-exchange based on the placement of a second trade in the second sub-exchange.

19. The method as in claim 17, wherein the movement of the first trade from the first sub-exchange to the second sub-exchange by the exchange is based on the trade quantity of the second trade.

20. The method as in claim 17, wherein the movement of the first trade from the first individual exchange to the second individual exchange by the composite exchange is based on the trade quantity of the first trade.
